(19) United States
(12) Patent Application Publication
(10) Pub. No.: US 2011/0011289 A1
(43) Pub. Date: Jan. 20, 2011

(54) ROTARY LITHOGRAPHIC PRINTING MACHINE

(75) Inventors: Rüdiger Böhm, Worth Am Rhein (DE); Axel Hauck, Karlsruhe (DE); Jörg Heuschkel, Viernheim (DE); Martin Mayer, Ladenburg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, HEIDELBERG (DE)

(21) Appl. No.: 12/844,469

(22) Filed: Jul. 27, 2010

Related U.S. Application Data
(63) Continuation of application No. PCT/EP2009/000531, filed on Jan. 28, 2009.

(30) Foreign Application Priority Data
Feb. 12, 2008 (DE) 10 2008 008 626.6
Feb. 12, 2008 (DE) 10 2008 008 628.2
Feb. 12, 2008 (DE) 10 2008 008 629.0

(51) Int. Cl. B41L 25/18

(52) U.S. Cl. 101/148

(57) ABSTRACT

A rotary lithographic printing machine includes an inking unit with a plurality of inking rollers and a dampening unit with a plurality of dampening rollers. One of the dampening rollers has a porous surface from which dampening solution emerges. At least two further rollers are disposed in a dampening solution flow between the dampening roller having the porous surface and a plate cylinder.

### CROSS-REFERENCE TO RELATED APPLICATION

This is a continuation, under 35 U.S.C. §120, of copending International Application No. PCT/EP2009/000531, filed Jan. 28, 2009, which designated the United States; this application also claims the priority, under 35 U.S.C. §119, of German Patent Applications DE 10 2008 008 628.2, filed Feb. 12, 2008, DE 10 2008 008 626.6, filed Feb. 12, 2008 and DE 10 2008 008 629.0, filed Feb. 12, 2008; the prior applications are herewith incorporated by reference in their entirety.

### BACKGROUND OF THE INVENTION

### Field of the Invention

The invention relates to a rotary lithographic printing machine including an inking unit having a plurality of inking unit rollers, and a dampening roller having a porous surface from which dampening solution emerges.

Rotary lithographic printing machines, that is to say for example web-fed or sheet-fed offset printing machines, normally have in each printing unit an inking unit with a plurality of inking unit rollers, which lead an ink flow from an ink reservoir, namely an ink fountain, to an offset printing plate on a plate cylinder and even it out and possibly distribute it laterally, etc. In addition, in so-called wet offset printing machines, a dampening unit is required, which wets the offset printing plate at hydrophilic points of the printing plate and ensures that the printing plate does not pick up any ink there. Dampening units of that type are normally constructed on the scoop principle, i.e. a so-called dip roller dips to some extent into a dampening solution fountain and a dampening solution film is transported from its surface through the use of further rollers to a dampening solution applicator roller resting on the plate surface.

In addition, so-called spray dampening units are also known, in which, instead of the dampening solution fountain and dip roller, use is made of a spray beam, with which a dampening solution film is sprayed onto the surface of one or more dampening unit rollers.

Furthermore, it is known from Japanese Patent Publication JP 05-064872 A and International Publication No. WO 2006/047997, corresponding to U.S. Patent Application Publication No. US 2007/0227374, to use so-called membrane rollers in the dampening unit, i.e. dampening rollers having a porous surface from which the dampening solution emerges. According to the prior art, those porous dampening rollers are set directly against the dampening solution applicator roller, amongst other reasons because the latter have a resilient roller shell, while the porous membrane roller is composed of sintered metal and, in that way, the result is a gap between the rollers that is easily adjustable in order to transport the dampening solution away, which would not be provided in the event of a contact between two hard rollers.

Given that configuration, inhomogeneities of the dampening solution on the roller surface are difficult to even out because of the short transfer path to the printing plate. Finally, there is still the problem that the dampening solution applicator roller to a certain extent also transfers ink back from the printing plate onto the porous dampening roller, so that the latter is contaminated and the pores are blocked with ink. That problem is also addressed in the aforementioned Japanese Patent Publication JP 05-064872 A.

### SUMMARY OF THE INVENTION

It is accordingly an object of the invention to provide a rotary lithographic printing machine, which overcomes the hereinafore-mentioned disadvantages of the heretofore-known machines of this general type and which reduces or avoids problems associated with the use of porous dampening rollers.

With the foregoing and other objects in view there is provided, in accordance with the invention, a rotary lithographic printing machine, comprising a plate cylinder, an inking unit having a plurality of inking unit rollers for supplying an ink flow to the plate cylinder and a dampening unit having a plurality of dampening unit rollers for supplying a dampening solution flow to the plate cylinder. One of the dampening unit rollers has a porous surface from which dampening solution emerges and at least two further rollers are disposed in the dampening solution flow between the dampening unit roller having the porous surface and the plate cylinder.

In a first embodiment, the porous dampening roller is set against the applicator roller belonging to the dampening unit and being contaminated with ink, through at least one further interposed roller in the dampening solution flow. As a result, it is possible to provide this interposed roller or these interposed rollers with a surface that repels ink, at least during operation, i.e. in the dampened state. In this way, the transport of ink back from the inking unit to the surface of the porous dampening roller can be reduced or prevented. Of course, it is also possible and expedient to provide the dampening roller itself with a surface that repels ink, at least during operation.

According to a second embodiment of the invention, the porous dampening roller is assigned to the inking unit and, at least during printing, is set against one or more of the inking unit rollers, either directly or through one or more intermediate rollers.

In this configuration, the otherwise necessary separate dampening unit can be dispensed with entirely, so that additional space becomes free on the periphery of the plate cylinder and, for example, can be used to integrate a washing device for the plate cylinder there. Nevertheless, the function of the dampening unit is ensured, since the dampening solution is emulsified into the ink transported by the inking unit and thus travels to the plate cylinder or the printing plate on this path.

It is expedient to set the porous dampening roller against the ink applicator roller or one of the ink applicator rollers of the inking unit, if appropriate through an intermediate roller, and in the case of inking units having three to four applicator rollers, at best against the first of the ink applicator rollers in the direction of rotation of the plate cylinder, as viewed in the direction out from the press nip. This therefore achieves the situation where the plate is already adequately dampened when the other ink applicator rollers “come into play.” Accordingly, scumming of the non-printing regions of the offset plate is avoided.

However, it is also possible to set the porous dampening roller directly or indirectly against a roller in the ink flow of the inking unit. Then, the dampening solution can be emulsified more homogenously into the ink.

The best position for the introduction of the dampening solution into the inking unit depends on the type of inking unit and its specific construction and can be determined by appropriate printing tests.

In the case of so-called short form inking units (anilox inking units), in which the ink is metered by a doctor and an engraved roller, it is conventional for only a single ink applicator roller to be provided. In this case, it is expedient to set the porous dampening roller against the ink applicator roller, possibly through one or two intermediate rollers. In particular, in conjunction with anilox inking units, the advantages of the porous dampening roller can be employed particularly well with regard to the most optimal utilization of the overall space in the printing unit.

The volume flow of the dampening solution which emerges from a porous dampening roller certainly depends on the internal pressure in the porous dampening roller but is otherwise time-invariant, i.e. constant, irrespective of how quickly printing is currently being carried out, i.e. how many plates per unit of time have to be dampened. It is therefore expedient to provide switching and/or actuating elements with the aid of which the pressure of the dampening solution in the interior of the porous dampening roller can be adjusted. Advantages are also offered by temperature control of the dampening solution which is supplied to the porous dampening roller. That is because the temperature of the dampening solution supplied to the plate should not be too high but rather should lie below the machine temperature, in order to obtain stable, continuous printing conditions. This becomes particularly important for the case in which printing is to be carried out with as little alcohol as possible or even no alcohol in the dampening solution, where therefore the cooling effect of isopropyl alcohol which otherwise evaporates becomes lower or disappears.

Furthermore, the porous dampening roller offers the possibility of metering the dampening solution zone by zone, i.e. of having it emerge from the roller shell in a different quantity in the axial direction. It therefore becomes possible to even print difficult print jobs, having a very inhomogeneous distribution of the subject on the printing plates, in a stable fashion. This is achieved by the interior of the porous dampening roller being composed of individual segments and by the pressure in the segments being independently adjustable.

If, despite the countermeasures described at the beginning, printing ink is deposited on the surface of the porous dampening roller, this leads to the emergence of the solution being partly suppressed at the points covered with ink. Furthermore, however, dampening solution emerges to an increased extent from the porous dampening roller in the neighboring regions, which leads to over-dampening of the printing plate at the non-image points. This effect is brought about by a flow of dampening solution in the axial direction within the porous carrier material of the dampening roller. In order to avoid this, it is therefore expedient to provide the porous carrier material of the dampening roller with an anisotropic structure which suppresses a flow of dampening solution parallel to the roller surface.

The same effect occurs if the membrane having the narrower pores, which constitutes the primary flow resistance as compared with the porous carrier material of the roller, is not applied to the inside but to the outside of the hollow cylindrical carrier material of the roller. Given such a formation, the surface of the porous dampening roller can in addition be freed better from ink residues by the dampening roller having an increased internal pressure applied, for example, in washing cycles.

Other features which are considered as characteristic for the invention are set forth in the appended claims.

Although the invention is illustrated and described herein as embodied in a rotary lithographic printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a four-color sheet-fed offset printing machine which is equipped with conventional film dampening units;

FIG. 2 is an enlarged, sectional view of an inking unit 8a in a printing unit 7a (showing a roller system) according to a first exemplary embodiment of the invention;

FIG. 3 is a further enlarged, fragmentary, sectional view of an exemplary embodiment of the invention, that is modified slightly as compared with FIG. 2;

FIG. 4 is a fragmentary, sectional view of a roller system of an exemplary embodiment of the invention for an anilox inking unit;

FIG. 5 is a schematic diagram illustrating the principle of a dampening solution circuit for a supply of porous rollers, for example a roller 34 in FIG. 2;

FIG. 6 is a view similar to FIG. 5 illustrating an alternative embodiment of the dampening solution circuit according to FIG. 5;

FIG. 7 is a sectional view of the inking unit 8a in the printing unit 7a (showing the roller system) according to a second exemplary embodiment of the invention;

FIG. 8 is a fragmentary, sectional view of an alternative exemplary embodiment of the inking unit according to FIG. 2;

FIG. 9 is a fragmentary, sectional view of the roller system of a further exemplary embodiment of the invention for an anilox inking unit;

FIG. 10A is a partly broken-away and partly enlarged sectional view of a porous dampening roller (membrane roller) suitable for the exemplary embodiments according to FIGS. 2 to 9;

FIGS. 10B and 10C are enlarged, fragmentary, sectional views showing two slightly different variants of a structure of a porous roller shell of the roller of FIG. 10A;

FIG. 11A is a partly broken-away and partly enlarged sectional view of a porous dampening roller constructed differently as compared with FIG. 10A;

FIG. 11B is an enlarged, fragmentary, sectional view showing a structure of a roller shell of the roller of FIG. 11A;

FIG. 12A is an elevational view illustrating the principle of a segmented porous dampening roller;

FIG. 12B is a fragmentary, partly longitudinal-sectional view of the roller of FIG. 12A in a plane containing a roller axis; and

FIG. 12C is an end-elevational view taken along the direction of the arrow VIc in FIG. 12A.

### DETAILED DESCRIPTION OF THE INVENTION

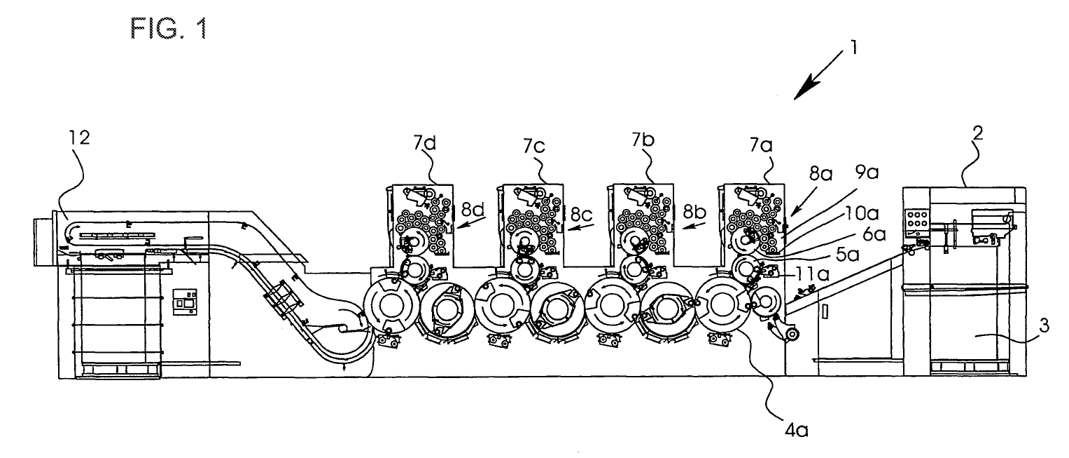

Referring now to the figures of the drawings in detail and first, particularly, to FIG. 1 thereof, there is seen an inline sheet-fed offset printing machine 1 that has a feeder 2, in which an unprinted paper stack 3 is located, as well as four printing units 7a-d for the four primary colors black, yellow, magenta and cyan. The fourth printing unit 7d is followed by a delivery 12 of the printing machine. In the latter, gripper bars circulate through the use of a chain guide. These gripper bars pick up the printed sheet and lead it to a sheet stack, where it is deposited.

The printing unit 7a has an impression cylinder 4a, a blanket cylinder 5a and a plate cylinder 6a, on which a respective printing plate is clamped. This is correspondingly true of the three other printing units 7b-d. The printing plates are inked by inking units 8a-d, the rollers of which cover a large part of the circumference of the plate cylinder. The respective inking unit, for example 8a, is adjoined by four rollers of a dampening unit 9a, of which a dip roller conveys dampening solution out of a dampening solution fountain 10a. Reference numeral 11a designates a cloth washing device for the blanket cylinder 5a of the printing unit 7a.

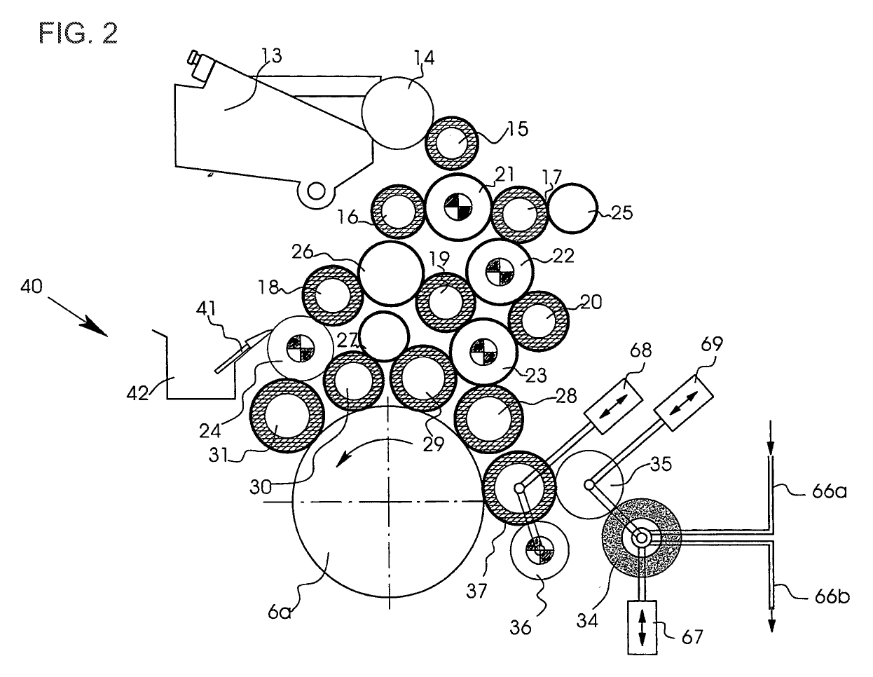

A combined inking and dampening unit according to the invention, as illustrated in FIG. 2, includes a knife or blade ink fountain 13, a ductor roller 14, four ink applicator rollers 28, 29, 30 and 31, with which the printing plate on the cylinder 6a is inked, and a series of further rollers 15 to 27, by which the ink is picked up from the ductor 14, is distributed and rubbed and then supplied to the applicator rollers. Reference numeral 15 designates an ink take-up roller swinging cyclically between the ductor roller 14 and the roller 21. The rollers 21, 22, 23 and 24 are traversing distributor rollers, with the distributors 23 and 24 being cooled. The roller 15 and the rollers 16, 17, 18, 19, 20, just like the four ink applicator rollers 28 to 31, are provided with a rubber cover, while the rollers 27, 26 and 25 are steel rollers.

A chromium plated distributor roller 36 is set against the dampening solution applicator roller 37. This is used to even out the dampening solution film of the applicator roller 37. The rough chromium layer is hydrophilic but tends to pick up ink if there is no dampening solution film on the surface of the distributor roller 36.

In addition, a porous dampening roller 34 is set against the dampening solution applicator roller 37 indirectly through an intermediate roller 35. This dampening roller 34, as indicated by a feed line 66a and a return line 66b, is connected to a dampening solution circuit with the aid of non-illustrated connections on a bearing journal of the roller 34. The dampening solution supplied through the line 66a floods the interior of the roller 34 and, given an appropriate overpressure, emerges through the porous roller shell, travels onto the intermediate roller 35 and is conveyed by the latter to the dampening solution applicator roller 37. The structure of the porous dampening roller 34 can be as described in International Publication No. WO 2006/047997, corresponding to U.S. Patent Application Publication No. US 2007/0227374, mentioned at the beginning, i.e. the porous dampening roller 34 can have a two-part structure with a membrane resting on the inside on the body of the porous roller 34 and having pores with a smaller diameter than the pores of the porous roller shell itself. However, it is also possible to fix a porous layer having relatively narrow pores to the outside of the roller 34 formed of porous sintered metal.

The intermediate roller 35 and the porous dampening roller 34 have an ink-repelling surface in order to prevent ink from being transported back from the printing plate clamped on the plate cylinder 6a to the porous dampening roller 34 and there blocking the pores through which the dampening solution is intended to pass. To this end, the roller 35 is provided on its surface with a fluoroelastomer layer or a silicon organic layer which has a low surface energy. Tetrafluoroethylene-hexafluoropropylene-vinylidene fluoride copolymer is, for example, suitable as a material for this purpose. As an alternative to this, the roller 35 can also, for example, be roughly chromium plated or provided with another hydrophilic metal or ceramic layer which, when wetted with dampening solution, has ink-repelling properties. On the other hand, the roller 34 is provided with a resilient, water-permeable layer. This can, for example, be a shrunk-on plastic membrane made of polysulfane or a thin layer of another water-permeable resilient plastic.

In addition, the roller 35 can also be thrown off the dampening solution applicator roller 37 through an actuator mechanism 69, and the roller 37 can be thrown off the plate cylinder 6a through an actuator mechanism 68. This therefore achieves the situation in which, following each printing interruption or before each resumption of printing operation, the hard, for example chromium plated, roller 35 is or can be firstly brought into contact with the porous dampening roller and a film of dampening solution thus builds up on its surface, before it comes into contact with the dampening solution applicator roller 37 possibly contaminated by ink. The actuator mechanism 68, with which the dampening solution applicator roller 37 is set against the printing plate on the plate cylinder 6a, ensures that the supply of dampening solution to the printing plate is carried out at the times at which the printing plate must be dampened before the start of the printing process.

A non-illustrated drive is provided for the two rollers 34 and 35, with which the rotational speed of the two rollers can be set independently of the rollers of the inking unit. This makes it possible to generate slippage between the rollers 35 and 37, with the aid of which the dampening solution supplied by the roller 35 is emulsified effectively into the ink layer on the dampening solution applicator roller 37. That layer forms as a result of the contact of the roller 37 with the inked printing plate.

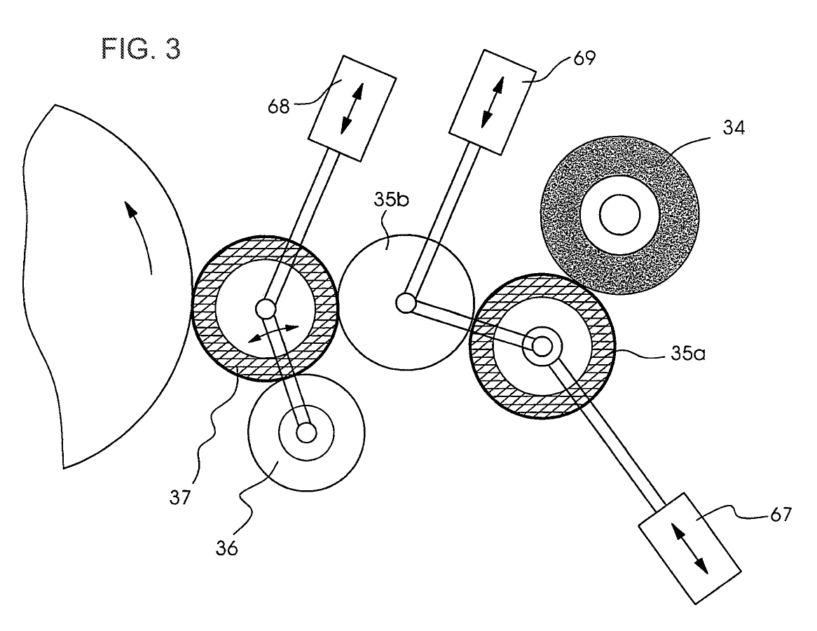

In a slightly modified exemplary embodiment of the invention according to FIG. 3, the porous dampening roller 34 is connected to the dampening solution applicator roller 37 through two intermediate rollers 35a and 35b. While the first intermediate roller 35a carries a rubber cover which is coated with a material of lower surface energy, such as a fluoroelastomer or a silicon organic compound, the second intermediate roller 35b has a ceramic or metal surface, for example a chromium surface. The combination of these two intermediate rollers is very well suited to prevent the transport of ink back from the dampening solution applicator roller 37 onto the porous dampening roller 34.

In order to divide the dampening solution roller train, the intermediate roller 35a can be lifted off the two rollers 34 and 35b by an actuator mechanism 67. As an alternative to this, the roller 35a can also remain in contact with the porous dampening roller 34 and be separated from the intermediate roller 35b through a pivoting movement about the axis of the roller 34. As illustrated in the figure, throwing the dampening unit off the plate cylinder is carried out by a pivoting movement of the roller 37 about the axis of rotation of the roller 36 with the aid of the actuator mechanism 68, while the hard roller 35 can be pivoted about the axis of rotation of the roller 35a by an actuator 69.

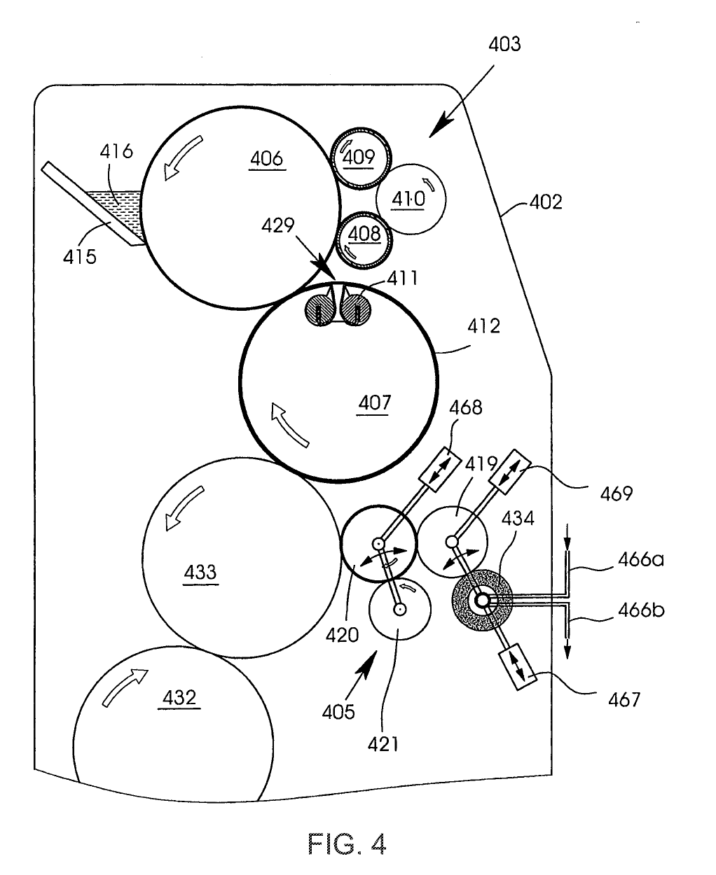

A printing unit 402 for offset printing with a short-form inking unit is illustrated in FIG. 4. The printing unit has a printing form cylinder 433, a blanket cylinder 432 and a so-called an “anilox” inking unit 403. The anilox inking unit 403 includes an engraved roller 406 and an ink applicator roller 407, which both have the same diameter as the printing form cylinder 433. In addition, the anilox inking unit 403 has two rollers 408 and 409 bearing on the engraved roller, and a roller 410, referred to as a third roller which, for its part, bears against the two rollers 408 and 409 in the manner of a bridge. As mentioned above, the ink applicator roller 407 has the same diameter as the engraved roller 406 and the printing form cylinder 433. However, it is provided with a clamping device 411 for clamping on a rubber blanket 412, with which the transfer of ink from the engraved roller 406 to the printing form cylinder 433 and the printing plate clamped on the latter is carried out. Reference numeral 415 designates an ink doctor, which bears on the engraved roller 406 and holds a supply of printing ink 416.

In the case of this sheet-fed offset printing machine with an anilox inking unit, a dampening unit 405 shown in the figure has a dampening solution applicator roller 420, a transfer roller 419 and a chromium plated distributor roller 421.

A porous dampening roller 434 is set against the transfer roller 419, which carries an ink-repelling coating. This roller 434 corresponds to the roller 34 according to FIG. 2 and, just like the latter, can be thrown off the roller 419 through an actuator 467 and, like the latter, is connected to the dampening solution circuit through lines 466a and 466b.

The hard, hydrophilic roller 419 can, in turn, be thrown off the roller 420 by a second actuator 469 by being pivoted about the axis of the roller 434, while the supply of dampening solution to the printing plate can be interrupted by an actuator 468, which pivots the roller 420 about the axis of the roller 421.

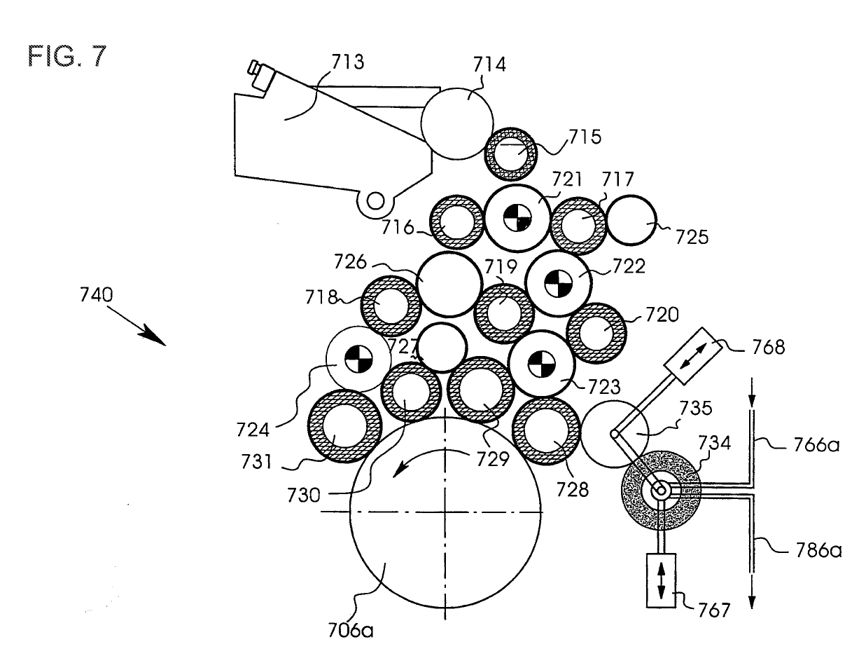

A combined inking and dampening unit according to the invention, illustrated in FIG. 7, includes a knife or blade ink fountain 713, a ductor roller 714, four ink applicator rollers 728, 729, 730 and 731, with which a printing plate on a cylinder 706a is inked, and a series of further rollers 715 to 727, by which the ink is picked up from the ductor 714, distributed and rubbed and then supplied to the applicator rollers. Reference numeral 715 designates an ink take-up roller swinging cyclically between the ductor 714 and the roller 721. The rollers 721, 722, 723 and 724 are traversing distributor rollers, with the distributors 723 and 724 being cooled. The roller 715 and the rollers 716, 717, 718, 719, 720, just like the four ink applicator rollers 728 to 731, are provided with a rubber cover, while the rollers 727, 726 and 725 are steel rollers.

A porous dampening roller 734 is set against the first ink applicator roller 728 indirectly through an intermediate roller 735. This dampening roller 734, as indicated by the feed line 766a and the return line 786a, is connected to a dampening solution circuit with the aid of non-illustrated connections on a bearing journal of the roller 734. The dampening solution supplied through the line 766a floods the interior of the roller 734 and, given an appropriate overpressure, emerges through the porous roller shell, travels onto the intermediate roller 735 and is conveyed by the latter to the ink applicator roller 728. The structure of the porous dampening roller 734 can be as described in International Publication No. WO 2006/047997, corresponding to U.S. Patent Application Publication No. US 2007/0227374, mentioned at the beginning, i.e. the porous dampening roller 734 can have a two-part structure with a membrane resting on the inside on the porous roller body 734 and having pores with a smaller diameter than the pores of the porous roller shell itself. However, it is also possible to fix a porous layer having relatively narrow pores to the outside of the roller 734 formed of porous sintered metal.

The intermediate roller 735 and the porous dampening roller 734 have an ink-repelling surface in order to prevent ink from being transported back from the ink applicator roller 728 to the porous dampening roller 734 and there blocking the pores through which the dampening solution is intended to pass. To this end, the roller 735 is provided on its surface with a fluoroelastomer layer or silicon organic layer which has a low surface energy. Tetrafluoroethylene-hexafluoropropylene-vinylidene fluoride copolymer is, for example, suitable as a material for this purpose. As an alternative to this, the roller 735 can also, for example, be roughly chromium plated or provided with another hydrophilic metal or ceramic layer which, when wetted with dampening solution, has ink-repelling properties. On the other hand, the roller 734 is provided with a resilient, water-permeable layer. This can, for example, be a shrunk-on plastic membrane made of polysulfane or a thin layer of another water-permeable, resilient plastic.

Furthermore, the dampening roller 734 can be thrown off the intermediate roller 735 through an actuator mechanism 767. The actuator mechanism 767 is connected to the control system of the printing machine, which ensures that the dampening roller 734 is set against the roller train only when dampening solution emerges from the surface of the roller and wets the surface, in order to ensure that adhesion of ink is avoided.

A further actuator mechanism 768 ensures that the roller 735 can be pivoted about the axis of the roller 734 and thus, together with the roller 734, can be thrown off the ink applicator roller 728. In this way, it is possible to dampen the roller 735 and therefore to make it ink-repelling before it comes into contact with the ink applicator roller 728.

The two rollers 734 and 735 have a non-illustrated drive, with which the rotational speed of the two rollers can be set independently of the rollers of the inking unit. This makes it possible to generate slippage between the rollers 735 and 728, with the aid of which the dampening solution supplied by the roller 735 is emulsified effectively into the ink layer on the ink applicator roller 728.

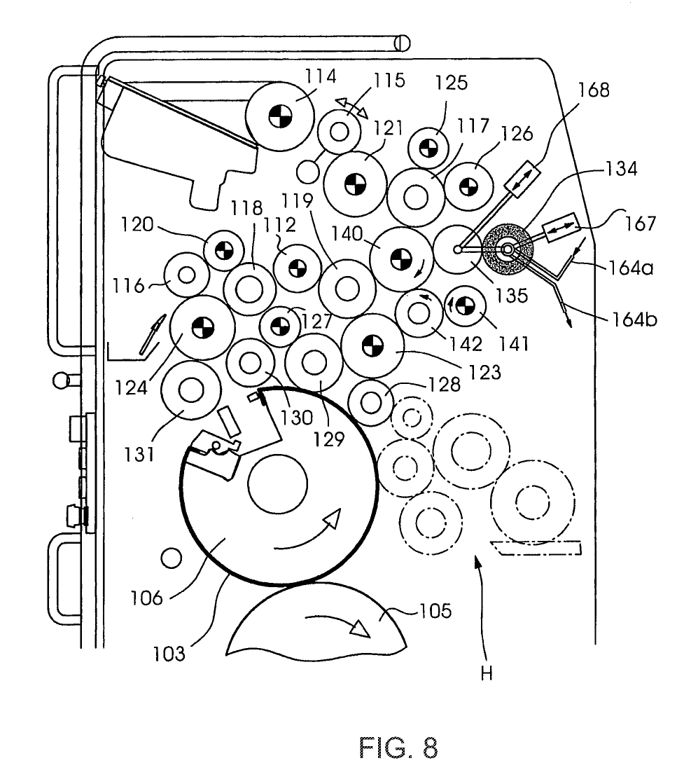

An inking unit modified in accordance with the invention and belonging to another sheet-fed offset printing machine, is illustrated in FIG. 8. Cylinders and rollers with a similar function as compared with the exemplary embodiment according to FIG. 7, bear reference numbers lower by 600 and will therefore not be explained once more in every case. This inking unit also has four ink applicator rollers 128 to 131, which are used to ink a printing plate 103 on a plate cylinder 106. Reference numeral 105 designates a blanket cylinder of the printing machine.

Conventionally, the printing plate 103 is wetted with dampening solution by a film dampening unit, as illustrated in a region H in which the rollers are shown in dashed lines. However, according to the invention, this is dispensed with. Instead, a porous dampening roller 134 is indirectly in contact with the surface of a distributor roller 140 of the inking unit through an intermediate roller 135. The roller 140 assumes a central position in the inking unit, in as much as the entire flow of ink picked up from a ductor roller 114 by an ink take-up roller 115 is led over it. Thus, in this case, at a central point, dampening solution is emulsified into the ink layer transported by the roller 140. This ink-dampening solution emulsion is then distributed through two further rollers 119 and 142 and rollers 122 and 123 as well as further rollers 116, 118, 120, 124 and 127 to the four ink applicator rollers. The printing plate 103 picks up the dampening proportion of the emulsion at its hydrophilic non-image points, while the image points are inked with ink.

In this exemplary embodiment, too, the dampening roller 134 can be thrown off the intermediate roller 135, and the latter can in turn be pivoted away from the roller 140 through an actuator 168. Of course, in this case, too, both rollers can be provided with an ink-repelling coating. In this case, the coating of the roller 135 is resilient and is therefore composed, for example, of a rubber coated with a fluoroelastomer, while the surface of the porous dampening roller 134 is hard and is formed of sintered metal or ceramic.

Furthermore, it is also possible to have the intermediate roller 135 run not only in contact with the roller 140 but also with the roller 141 of the inking unit, if the diameter of the latter roller is matched to the roller 140. In this way, even better emulsification of the dampening solution into the ink can be achieved.

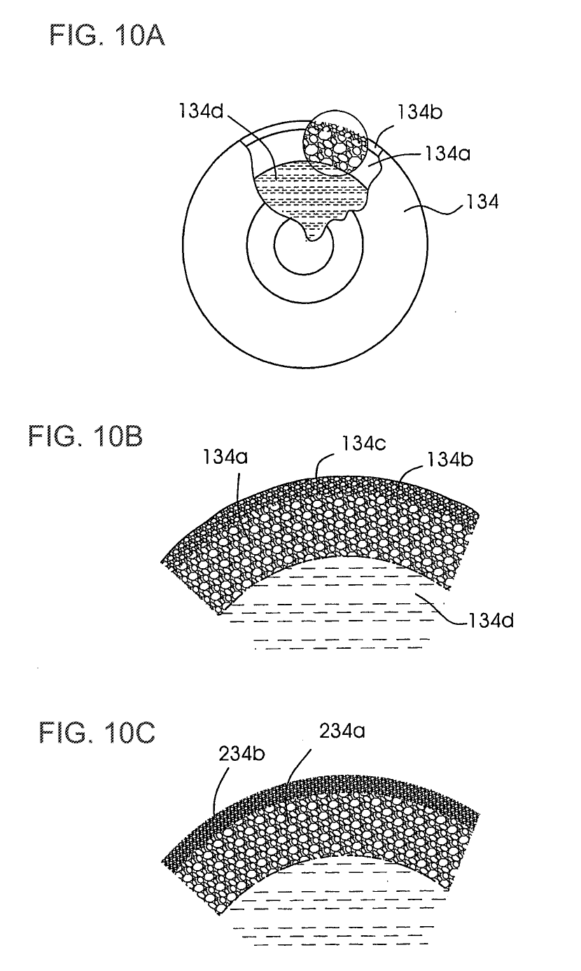

The porous dampening roller 134 is illustrated in more detail in FIGS. 10A to 10C. It includes a porous carrier sleeve 134a of sintered metal having a thickness of several millimeters. Applied to the outside of the carrier sleeve 134a is a porous ceramic layer 134b of, for example, titanium dioxide with a thickness of a few tenths of a millimeter. In the course of the sintering of the titanium dioxide powder from which it has been produced, this layer 134b is connected firmly to the carrier sleeve 134a. The pores in this ceramic layer 134b are very much smaller than the pores in the carrier sleeve 134a of sintered metal. For instance, the pore size in the sintered metal is around 1 micrometer, and the pore size in the ceramic layer 134b is around 0.1 micrometer.

However, these are only exemplary statements. The pore size may be varied within wide limits by choosing the granulation of the ceramic or metal powder to be sintered and the management of the process during sintering and thus matched to the requirements in the individual case in such a way that, with a given pressure range for the dampening solution 134d and the dimensions of the roller 134, the desired dampening solution volume flow is established.

In addition, it is also possible to produce an outer membrane by applying a layer to the carrier sleeve 134a and subsequently perforating it by electron beams, laser beams or by etching.

If the hydrophilic properties of the ceramic layer 134b or its lipophobic properties are inadequate, a lipophobic layer 134c is additionally vapor deposited on the surface of the ceramic layer 134b, as illustrated in FIG. 10b, specifically in a thickness of a few nanometers, in order to ensure that the pores in the, for example, porous titanium dioxide layer 134b are not blocked by the additionally vapor deposited layer 134c.

As illustrated in the slightly modified exemplary embodiment according to FIG. 10c, this layer can be dispensed with if ceramic material of a layer 234b is itself sufficiently hydrophilic or the surfaces of the granules 234a of which the ceramic layer 234b is formed are already hydrophilically or lipophobically coated before the sintering.

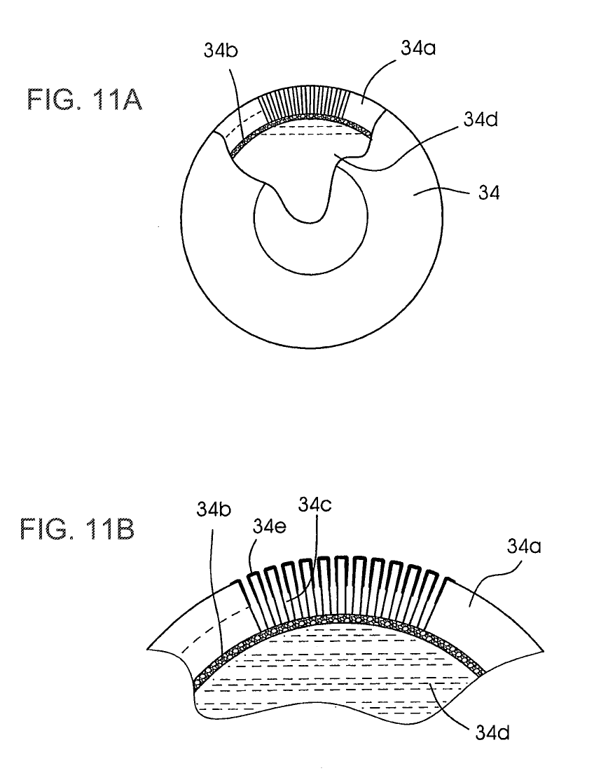

An alternative exemplary embodiment of the roller 134 according to FIGS. 10A to 10C is illustrated in FIGS. 11A to 11B. In this case, for example, the roller can be the dampening roller 34 of FIG. 2. This roller has a carrier sleeve 34a of metal that is several millimeters thick, which is provided with a large number of capillary-like drilled holes 34c. The capillaries have a diameter of several micrometers and can have been introduced into the carrier sleeve, for example mechanically through the use of electron beams, by laser beams or by etching. Located on the inside of the sleeve 34a is a water-permeable plastic membrane 34b, for example of polysulfane. Alternatively, the membrane layer 34b can also be formed of a sintered ceramic or a sintered metal. The pores of the sintered ceramic or of the sintered metal, at several tenths of a micrometer, are small as compared with the diameter of the drilled holes 34c.

The material of the metal sleeve 34a can, for example, be aluminum or steel. The surface of the roller 34 is preferably constructed to be rough and, as indicated by the reference symbol 34e, can additionally be provided with a chromium layer, which also penetrates partly into the interior of the capillaries 34c.

The membrane layer 34b constitutes the greatest flow resistance for the dampening solution 34d in the interior of the dampening roller 34. The dampening solution that has passed through in this case travels into the capillaries 34c and can then only emerge to the outside radially. In particular, it no longer has any possibility of forming a surface flow parallel to the roller surface if individual capillaries have been blocked, for example by ink transported back. The same is true of the roller 134 in FIG. 4. There, the outer layer 134b constitutes the greatest flow resistance. Although, in the extreme case, blockage of the pores of this layer can have the effect of a rise in the internal pressure of the roller overall, filled individual regions on the surface of the layer 134b do not lead to dampening solution emerging more intensely in regions beside the points on the surface of the roller 134b that are filled with ink, if the internal pressure of the dampening solution 34d is kept constant.

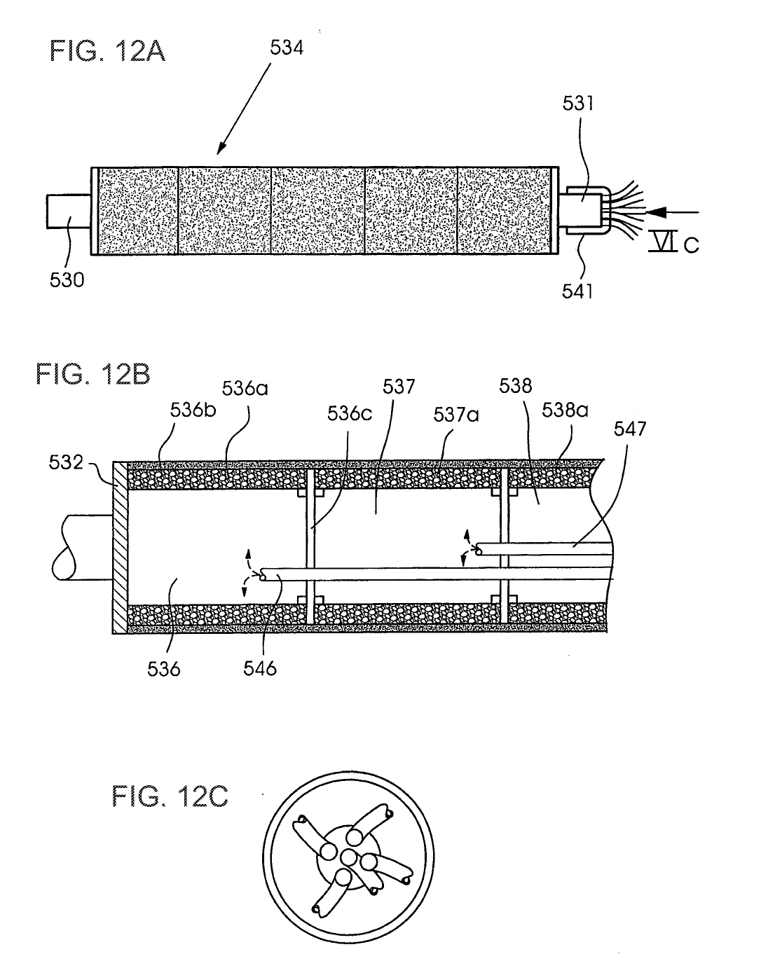

An exemplary embodiment of a further porous dampening roller 534 can be seen in more detail in FIGS. 12A to 12C. This roller 534 is divided up into five segments 536, 537, 538 . . . supplied individually with dampening solution. These segments are supplied through feed pipes 546, 547 . . . from corresponding feed lines on a rotary leadthrough 541 on a journal 531 of the roller 534, which is seen in FIG. 12C that is taken in the direction of the arrow XIII in FIG. 12A.

As far as the roller shell is concerned, the individual partial segments 536, 537, 538 . . . are constructed in a similar way to the roller 134 in FIGS. 10A to 10C, namely from sintered stainless steel carrier sleeves 536a, 537a, 538a . . . which in this exemplary embodiment are sealed off with respect to one another at the ends by disk-like wall pieces 536c. A thin sintered ceramic layer 536b is then applied to the outside of the carrier structure including the segment sleeves and extends over the entire length of the roller 534 (with the single exception of an end wall 532 and journals 530, 531).

The emergence of the dampening solution from the porous surface of the roller can be controlled zone by zone by controlling the pressure of the dampening solution in the interior of the segments 536, 537, 538 . . . . It is therefore possible to supply different quantities of dampening solution locally to the printing plate through the use of such a roller. In this way, in the case of specific subjects, continuous printing becomes more stable or, in the case of spot subjects, the printer has greater freedom in the setting of the dampening solution balance.

It can also be advantageous if a gumming agent, for example, carboxymethyl cellulose (CMC) is added to the dampening solution. On the surface of the dampening rollers described with regard to FIGS. 4 to 6, this substance forms a hydrophilic film which largely prevents the blockage of the porous surface with printing ink being conveyed back.

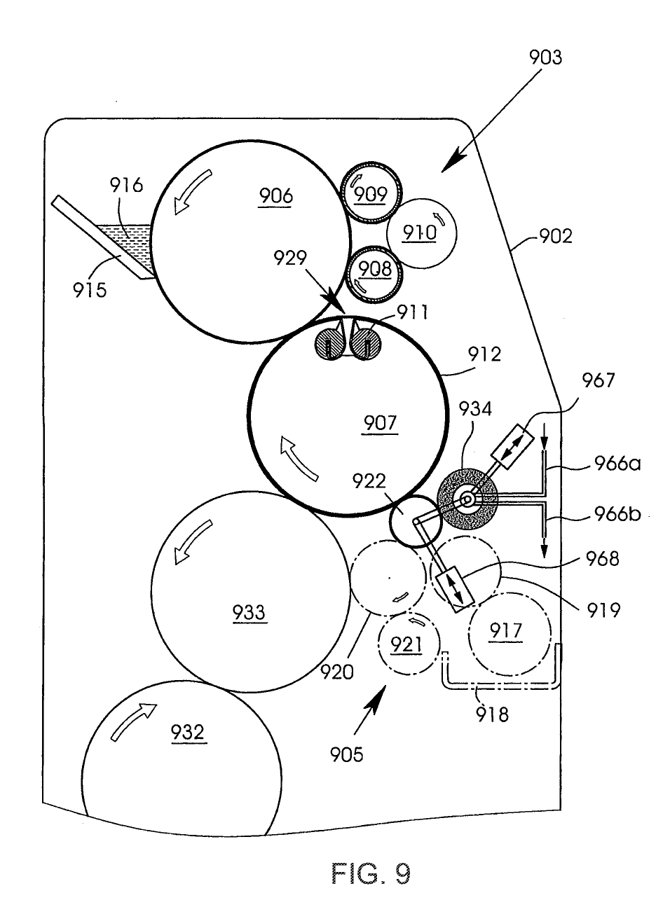

A printing unit 902 for offset printing with a short-form inking unit is illustrated in FIG. 9. The printing unit has a printing form cylinder 933, a blanket cylinder 932 and a so-called an “anilox” inking unit 903. The anilox inking unit 903 includes an engraved roller 906 and an ink applicator roller 907, both of which have the same diameter as the printing form cylinder 933. In addition, the anilox inking unit 903 includes two rollers 908 and 909 bearing against the engraved roller and a roller 910, which is a third roller, in turn bearing against both rollers 908 and 909 in the manner of a bridge. As mentioned above, the ink applicator roller 907 has the same diameter as the engraved roller 906 and the printing form cylinder 933. However, it is provided with a clamping device 911 for clamping on a rubber blanket 912, with which the transfer of ink from the engraved roller 906 to the printing form cylinder 933 and the printing plate clamped on the latter is carried out. Reference numeral 915 designates an ink doctor, which bears against the engraved roller 906 and holds a supply of printing ink 916.

In a known sheet-fed offset printing machine marketed by the corporate assignee of the instant application and having an anilox inking unit, a dampening unit 905 shown in dashed lines in the figure, including a dampening solution fountain 918, a dip roller 917, a transfer roller 919, a dampening solution applicator roller 920 and a chromium plated distributor roller 921, is included. According to the invention, that dampening unit can be dispensed with, which creates space for other auxiliary units, such as a washing device.

Instead, a porous dampening roller 934 is set against a remaining bridge roller 922, which carries an ink-repelling coating. This roller 934 corresponds to the rollers 34 and 134 according to FIGS. 2 and 8 and, just like the latter, can be thrown off the roller 922 by an actuator 967 and, like the latter, is connected to the dampening solution circuit through lines 966a and 966b. Likewise, the roller 922 can be pivoted away from the rubber blanket 912 about the axis of the roller 934 by an actuator 968.

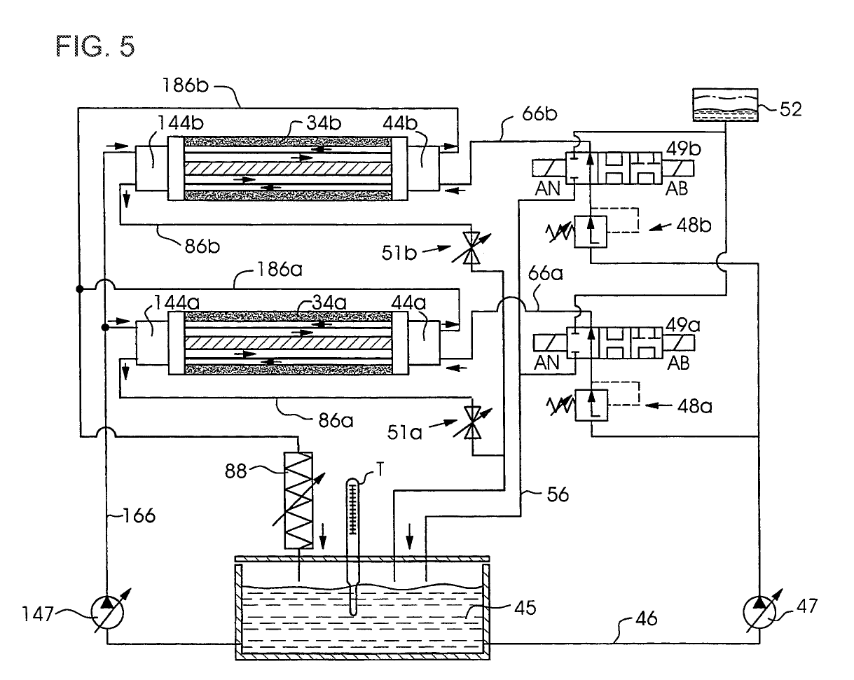

In FIG. 5, illustrating the principle according to the invention, a dampening solution circuit for supplying the membrane rollers illustrated in the exemplary embodiments for two printing units, is shown. In this case, the dampening solution, which is conditioned and possibly offset with additives and temperature-controlled through non-illustrated devices, for supplying all of the printing units of the printing machine, is located in a storage container 45. A pump 47 delivers the dampening solution through a line 46 into feeds 66a and 66b for two porous dampening rollers 34a and 34b as shown. The dampening solution travels into the interior of the rollers 34a and 34b through rotary leadthroughs in bearing journals 44a and 44b. Respective pressure reducers 48a and 48b and multiway valves 49a and 49b are disposed between the pump 47 and the feed lines 66a and 66b.

The pressure reducers 48a and 48b allow the internal pressure in the membrane roller to be set separately for each printing unit, specifically to the value required during printing operation, depending on the printing speed, in order to ensure that the printing plate is supplied adequately with dampening solution even at higher printing speeds. This is symbolized by corresponding arrows. For this purpose, the pressure reducers 48a, 48b are connected to the non-illustrated control system of the printing machine.

The multiway valves 49a, 49b permit the internal pressure of the membrane rollers to be switched back quickly from the operating pressure predefined through the pressure reducers 48a, 48b (that is the switching position shown) to a value at which no dampening solution emerges from the membrane roller. In this case, when the dampening is to be interrupted (pressure off), the line 66a is blocked off from the feed and at the same time connected to a compensating vessel 52, so that the overpressure in the roller 34 can be relieved quickly in this way. A few tenths of a second after that, a further switch is then made to a third position, in which the membrane rollers are also isolated from the compensating vessel 52.

Reference numerals 51a and 51b designate shut-off valves in return lines 86a and 86b. These valves can be opened at relatively large time intervals, in order to flush through the roller interior and thus to free it of deposits under the porous membrane of the rollers 34a, 34b.

A second circuit, which originates from the storage container 45, includes a pump 147 and a feed line 166 with which a very much higher volume flow is pumped through the rollers 34a, 34b at rotary leadthroughs in bearing journals 44a and 44b for the purpose of controlling the temperature of the latter. In the interior of the rollers 34a, 34b, this circuit is isolated from the actual dampening solution flow by a thin, highly thermally conductive sleeve. In return lines 186a, 186b of the temperature controlled circuit, there is a cooling and heating device 88, which is activated by a temperature sensor T in the storage vessel 45.

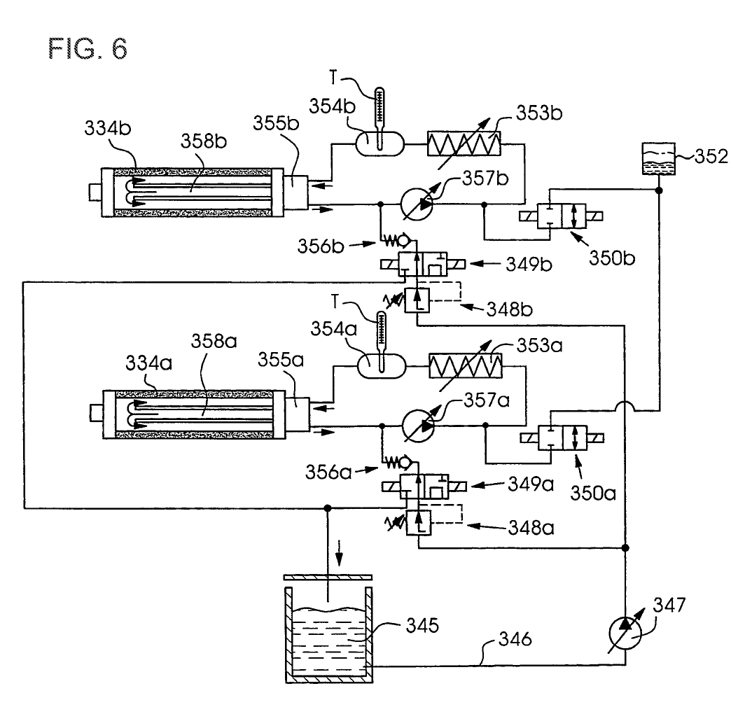

An exemplary embodiment for the dampening solution circuit, which is modified with respect to FIG. 5, is illustrated in the exemplary embodiment according to FIG. 6. In this case, the interior of dampening rollers 334a and 334b is only connected to the dampening solution circuit from one side through respective bearing journals and multichannel rotary leadthroughs 355a and 355b connected thereto. With the aid of separate pumps 357a and 357b, permanently temperature-controlled dampening solution is circulated through the interior of the dampening rollers 334a, 334b of the respective printing units as well as through cooling elements 353a, 353b in conjunction with mixing units 354a, 354b separately controlling the temperature of the circulating dampening solution for the rollers 334a, 334b and keeping it at the temperature desired for the respective printing unit.

Changeover valves 350a and 350b make it possible to quickly de-pressurize the rollers 334a and 334b in the respective self-contained, pre-pressurized dampening solution circuits when necessary.

The circuits are supplied through nonreturn valves 356a and 356b from a dampening solution storage vessel 345. In this case, a pump 347 in a feed line 346 in conjunction with pressure reducers 348a and 348b in each case ensure that the desired pressure is maintained in the self-contained temperature control circuits for the respective roller 334a and 334b.

A rapid reduction in the pressure level in the closed temperature-controlled dampening solution circuit can be achieved through changeover valves 349a and 349b. These valves then isolate the pre-pressurized combined dampening solution supply and temperature control circuits for the rollers 334a and 334b from the dampening solution supply, while at the same time the changeover valves 350a and 350b let down the pressure from the interior of the rollers 334a and 334b into a compensating vessel 352.

Before the printing machine illustrated in FIGS. 2, 3 and 4 goes to “print on” again following an interruption or during the first-time printing of a new print job, the water pressure in the dampening rollers in all of the printing units is switched on and the respective porous dampening roller 34, 434 is set against the associated intermediate roller 35, 419 by the first actuator 67 or 467. A few seconds after that, when the rollers 35 to 37 of the dampening unit have been provided with a dampening solution film, they are then set against the printing plates on the plate cylinders 6a to 6d in the respective printing units 7a to 7d by the second actuator 68 or 438. In this way, it is ensured that the surfaces of the rough chromium plated distributor rollers 36 and 421 are given a dampening solution film before they can pick up ink due to the contact between the dampening solution applicator roller 37 or 420 and the printing plate.

1. A rotary lithographic printing machine, comprising:
a plate cylinder;
an inking unit having a plurality of inking unit rollers for supplying an ink flow to said plate cylinder;
a dampening unit having a plurality of dampening unit rollers for supplying a dampening solution flow to said plate cylinder;
one of said dampening unit rollers having a porous surface from which dampening solution emerges; and
at least two further rollers disposed in the dampening solution flow between said dampening unit roller having said porous surface and said plate cylinder.

2. The rotary lithographic printing machine according to claim 1, wherein said at least two further rollers are dampening unit rollers, and at least one of said dampening unit rollers has a surface constructed to repel ink, at least in a dampened state.

3. The rotary lithographic printing machine according to claim 1, wherein said dampening roller having said porous surface is set, directly or indirectly through at least one roller, against one of said inking unit rollers or an ink applicator roller in the ink flow of said inking unit during printing.

4. The rotary lithographic printing machine according to claim 2, wherein said dampening solution roller having said porous surface is set, through at least one intermediate roller, against a first of a plurality of ink applicator rollers in a direction of rotation of said plate cylinder out of a press nip.

5. The rotary lithographic printing machine according to claim 1, wherein said dampening solution roller having said porous surface is set, through at least one intermediate roller, against one of said inking unit rollers in the ink flow of said inking unit.

6. The rotary lithographic printing machine according to claim 1, wherein said dampening solution roller having said porous surface is set, through at least one intermediate roller, against at least one distributor roller of said inking unit.

7. The rotary lithographic printing machine according to claim 1, which further comprises switching or actuating elements for adjusting a dampening solution pressure in an interior of said dampening roller having said porous surface.

8. The rotary lithographic printing machine according to claim 1, which further comprises a temperature control device for adjusting a dampening solution temperature in an interior of said dampening roller having said porous surface.

9. The rotary lithographic printing machine according to claim 1, which further comprises a throw-off device for interrupting contact between said dampening roller having said porous surface and other rollers of said dampening unit.

10. The rotary lithographic printing machine according to claim 1, which further comprises a throw-off device for throwing-off contact between rollers in the damping solution flow and ink-carrying rollers.

11. The rotary lithographic printing machine according to claim 1, wherein at least one of said dampening roller having said porous surface or at least one intermediate roller or a roller on which said dampening roller having said porous surface rests, has a surface repelling ink, at least in a dampened state.

12. The rotary lithographic printing machine according to claim 11, wherein said surface repelling ink is a fluoroelastomer layer or a silicon organic layer.

13. The rotary lithographic printing machine according to claim 11, wherein said surface repelling ink is hydrophilic and formed of metal or ceramic.

14. The rotary lithographic printing machine according to claim 1, wherein said dampening roller having said porous surface has an interior including individual segments having independently adjustable pressure.

15. The rotary lithographic printing machine according to claim 1, wherein said dampening roller having said porous surface has a porous roller body having an anisotropic structure causing a flow resistance in axial direction within said porous roller body to be greater than a flow resistance in radial direction through said roller body.

16. The rotary lithographic printing machine according to claim 1, wherein said dampening roller having said porous surface has a roller body with pores and an outer water-permeable membrane with pores, and said pores in said membrane are smaller than said pores of said roller body.

17. The rotary lithographic printing machine according to claim 16, wherein said membrane is constructed to repel ink, at least over an outer surface of said membrane.

18. The rotary lithographic printing machine according to claim 15, wherein said dampening roller having said porous surface has a dimensionally stable carrier having pores formed as drilled through holes or ducts.

19. The rotary lithographic printing machine according to claim 15, wherein said roller body has an outer surface provided with an ink-repelling coating.

20. The rotary lithographic printing machine according to claim 1, which further comprises a cleaning device to be set against said dampening roller having said porous surface.

21. The rotary lithographic printing machine according to claim 1, wherein said dampening roller having said porous surface has an interior receiving a dampening solution containing a gumming agent.
